(19) United States
(12) Patent Application Publication
(10) Pub. No.: US 2010/0168899 A1
(43) Pub. Date: Jul. 1, 2010

(54) PRODUCT VERIFICATION SYSTEM

(76) Inventors: Cheng-Yung Teng, Taipei County (TW); Chih-Kai Chang, Taipei City (TW)

Correspondence Address: Muncy, Geissler, Olds & Lowe, PLLC, 4000 Legato Road, Suite 310, FAIRFAX, VA, 22033, US

(21) Appl. No.: 12/650,391

(22) Filed: Dec. 30, 2009

(30) Foreign Application Priority Data
Dec. 30, 2008 (TW) 097151365

(51) Int. Cl. G06F 19/00

(52) U.S. Cl. 700/110; 700/121

(57) ABSTRACT

A product verification system with at least two machines that communicate with each other by an inferred mechanism is provided. The first machine is a handler and the second machine is a tester. The second machine is coupled to a product, and performs a test procedure on the product according to a test command from the first machine. The test result is collected and transmitted back to the first machine by the second machine.

### CROSS REFERENCE TO RELATED APPLICATIONS

This Application claims priority of Taiwan Patent Application No. 097151365, filed on Dec. 30, 2008, the entirety of which is incorporated by reference herein.

### BACKGROUND OF THE INVENTION

1. Field of the Invention

The present invention relates to product verification systems, and in particular relates to product verification systems having at least two separate machines.

2. Description of the Related Art

Before a slicing process is performed on a semiconductor wafer, a verification procedure is required to identify bad dies thereon, to decrease cost of a subsequent semiconductor packaging process.

One well-known verification procedure utilizes a wafer probe. For example, a detector, equipped with a probe as thin as hair, tests all dies on a wafer. The probe contacts the pads of a die, so that electrical characteristics of the die may be verified and bad dies may be marked. The marked dies are then eliminated before the semiconductor packaging process, thus, reducing costs.

The invention discloses product verification systems.

### BRIEF SUMMARY OF THE INVENTION

The invention discloses product verification systems, comprising a first machine and a second machine. The first machine is a handler, and comprises a first inferred (IR) transceiving module, a first control unit and a storage unit. The second machine is a tester and is coupled to a product. The second machine comprises a second IR transceiving module and a second control unit.

The first and second IR transceiving modules control communication between the first and second machines. The first control unit provides the first IR transceiving module with a test command. The first IR transceiving module transmits the test command to the second IR transceiving module by infrared. When receiving the test command, the second IR transceiving module sends the test command to the second control unit. The second control unit tests the product according to the test command and collects the test result and then sends the test result to the second IR transceiving module. The second IR transceiving module transmits the test result to the first IR transceiving module by infrared. The first IR transceiving module sends the received test result to the first control unit, and the first control unit stores the test result in the storage unit. The data stored in the storage unit is used for analysis of the test result.

Because the IR mechanism realized in the communication between the first and second machines is a wireless technique, no wires are required between the first and second machines. Thus, system complexity and maintenance costs of communication wires are reduced. Furthermore, RF noise interference or antenna effect and so on, associated with other communication techniques when verifying radio frequency (RF) chips, are eliminated. Compared with other wireless communication techniques, the IR communication technique improves reliability of test results. Thus, the product verification systems of the invention can be widely applied for all kinds of chips.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an exemplary embodiment of the product verification systems of the invention;

FIG. 2 depicts an exemplary embodiment of the first machine 102;

FIG. 3 depicts an exemplary embodiment of the second machine 104; and

FIG. 4 depicts an exemplary embodiment of transmission formats between the first and second machines 102 and 104.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

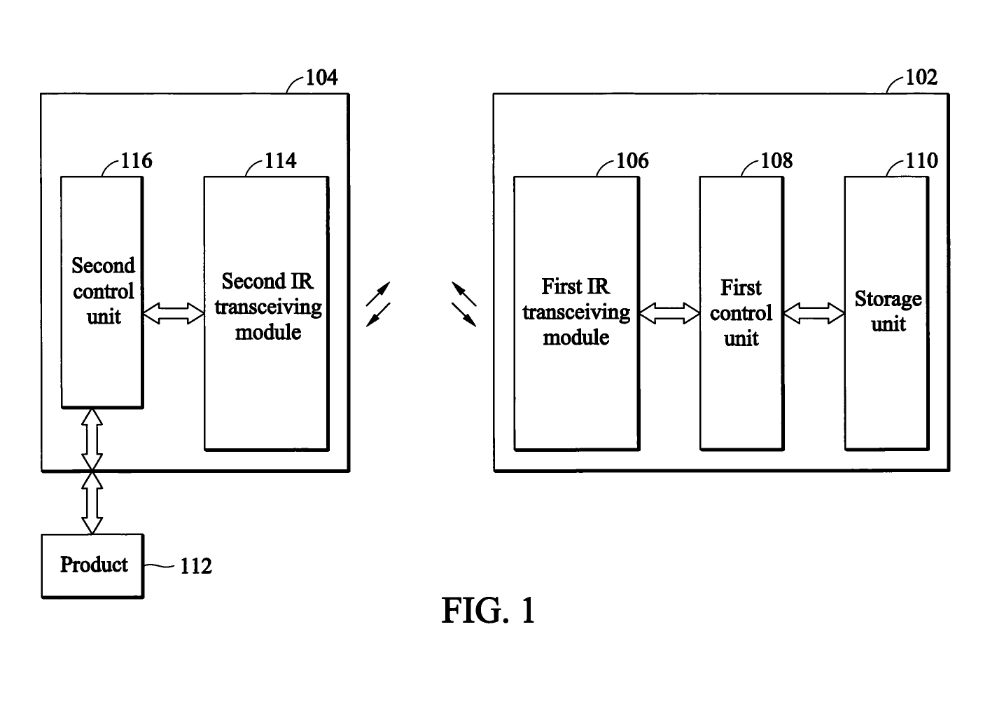

FIG. 1 depicts an exemplary embodiment of the product verification systems of the invention. As shown, there is a first machine 102 and a second machine 104 that communicate with each other by an inferred (IR) mechanism.

The first machine 102 is a handler, and comprises a first IR transceiving module 106, a first control unit 108 and a storage unit 110. The second machine 104 is a tester and is coupled to a product 112. The second machine 104 comprises a second IR transceiving module 114 and a second control unit 116.

The first and second IR transceiving modules 106 and 114 realize the IR communication between the first and second machines 102 and 104.

The first control unit 108 provides a test command to be transmitted by the first IR transceiving module 106 and then be received by the second IR transceiving module 114. The second IR transceiving module 114 sends the received test command to the second control unit 116. According to the test command, the second control unit 116 tests the product 112 and collects the test result. The product 112 may be a die on a semiconductor wafer or a separate die sliced from a wafer. The test procedure may be a wafer probe test or a test for electrical characteristics.

The second machine 104 uses the second IR transceiving module 114 thereof to transmit the test result to the first IR transceiving module 106 of the first machine 102. The first IR transceiving module 106 sends the received test result to the first control unit 108. The first control unit 108 stores the test result in the storage unit 110. The data in the storage unit 110 may be collected to analyze the test results.

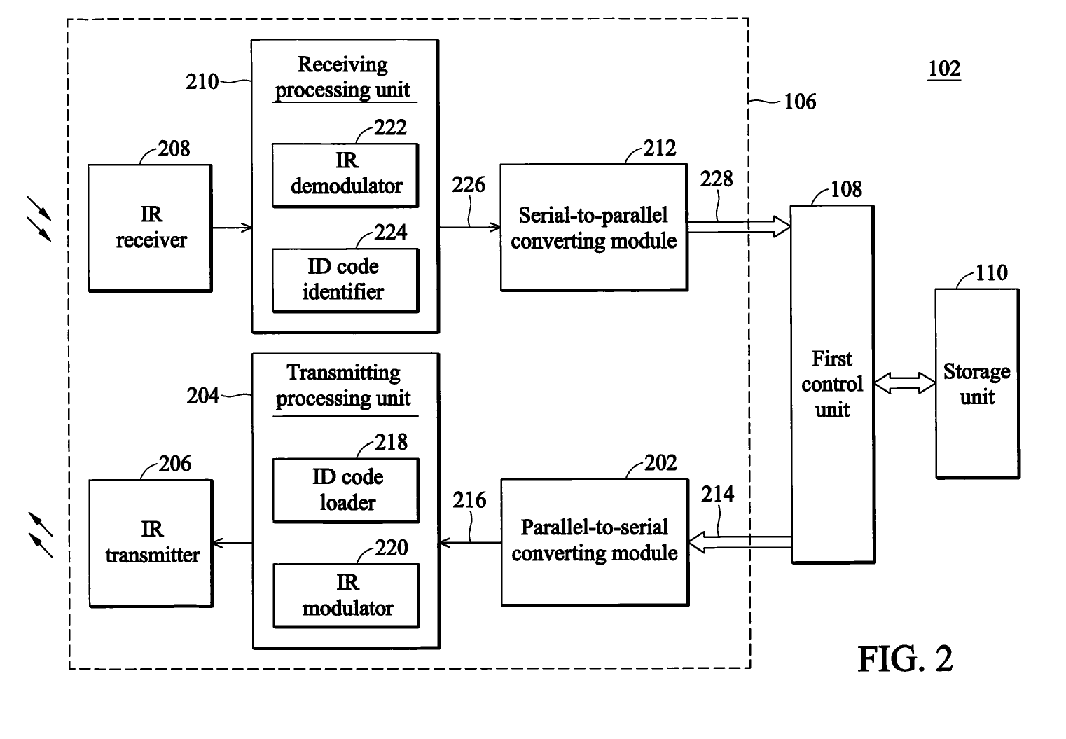

FIG. 2 depicts an exemplary embodiment of the first machine 102. A shown, the first IR transceiving module 106 comprises a parallel-to-serial converting module 202, a transmitting processing unit 204, an IR transmitter 206, an IR receiver 208, a receiving processing unit 210 and a serial-to-parallel converting module 212. The first control unit 108 communicates with other devices by parallel communication.

This paragraph discusses how the first machine 102 transmits the test command by the IR mechanism to the second machine 104. Referring to FIG. 2, the first control unit 108 outputs a parallel format test command 214. The parallel-to-serial converting module 202 converts the parallel format test command 214 to a serial format test command 216. The transmitting processing unit 204 comprises an identification (ID) code loader 218 and an IR modulator 220, which loads the serial format test command 216 with an ID code of the first machine 102 and performs an IR modulation process to the serial format test command loaded with the ID code. The transmitting processing unit 204 outputs an IR modulated test command to the IR transmitter 206, and the IR transmitter 206 transmits the IR modulated test command by infrared. The infrared test command is received by the IR transceiving module 114 of the second machine 104.

This paragraph discusses how the first machine 102 receives the test result from the second machine. Referring to FIG. 2, the IR receiver 208 receives IR signal and then sends the received IR signal to the receiving processing unit 210. The receiving processing unit 210 comprises an IR demodulator 222 and an ID code identifier 224, which demodulates the IR signal and identifies the ID code thereof. When the ID code belongs to the second machine 104, the data in the IR signal is the test result from the second machine 104. Because data transmitted in the IR signal is of a serial format but the first control unit 108 uses a parallel communication, the serial-to-parallel converting module 212 is designed between the receiving processing unit 210 and the first control unit 108 to convert the serial format test result 226 to a parallel format test result 228. The first control unit 108 stores the parallel format test result 228 in the storage unit 110.

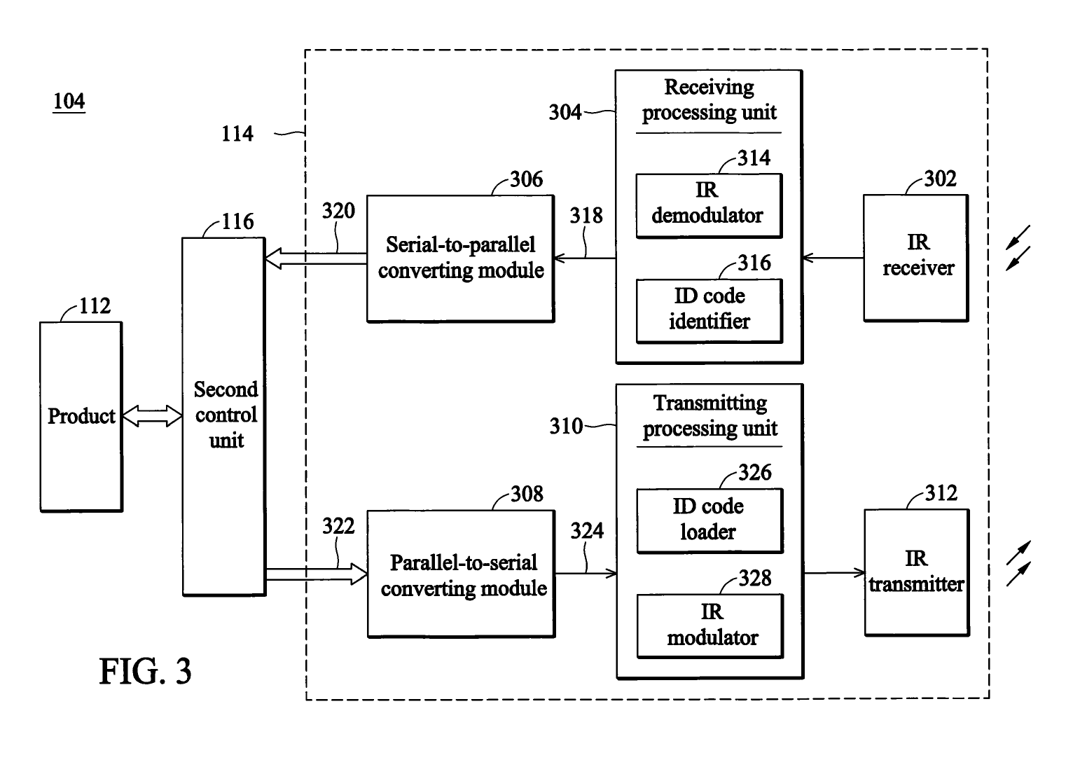

FIG. 3 depicts an exemplary embodiment of the second machine 104. As shown, the second IR transceiving module 114 comprises: an IR receiver 302, a receiving processing unit 304, a serial-to-parallel converting module 306, a parallel-to-serial converting module 308, a transmitting processing unit 310 and an IR transmitter 312. The second control unit 116 communicates with other components by a parallel communication.

This paragraph discusses how the second machine 104 receives the test command from the first machine 102. Referring to FIG. 3, when receiving the IR signal, the IR receiver 302 sends the IR signal to the receiving processing unit 304. The receiving processing unit 304 comprises an IR demodulator 314 and an ID code identifier 316, which demodulates the IR signal and identifies the ID code thereof. When the ID code belongs to the first machine 102, the data transmitted by the IR signal is the test command from the first machine 102. Because data transmitted in the IR signal is of the serial format but the second control unit 116 uses a parallel communication, the serial-to-parallel converting module 306 converts the serial format test command 318 to a parallel format test command 320 and sends the parallel format test command 320 to the second control unit 116. According to the test command 320, the second control unit 116 tests the product 112 and collects the test result.

This paragraph discusses how the second machine 104 transmits the test result by the IR mechanism to the first machine 102. Referring to FIG. 3, the second control unit 116 sends a parallel format test result 322 to the parallel-to-serial converting module 308 to generate a serial format test result 324. The serial format test result 324 is sent to the transmitting processing unit 310. The transmitting processing unit 310 comprises an ID code loader 326 and an IR modulator 328, which loads the serial format test result 324 with the ID code and performs an IR modulation process to the serial format test result loaded with the ID code. The transmitting processing unit 310 outputs an IR modulated test result. The IR modulated test result is sent to the IR transmitter 312 to be transmitted to the first machine 102 by infrared.

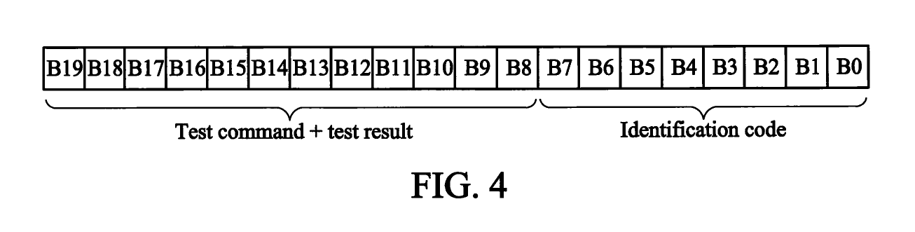

FIG. 4 depicts an exemplary embodiment of transmission formats between the first and second machines 102 and 104. As shown, there are 20 bits. Bits B0˜B7 represent the ID code. Bits B8˜B19 include information about test commands or test results.

The test command may enable the second machine 104 to perform a specific test procedure on the product 112. The test result may be shown by flags, which show pass, fail and error statuses.

The transmission format shown in FIG. 4 is not intended to limit the transmission formats between the first and second machines 102 and 104, thus, any transmission format may be used.

Because the IR mechanism realized in the communication between the first and second machines is a wireless technique, no wires are required between the first and second machines. Thus, system complexity and maintenance costs of communication wires are reduced. Furthermore, RF noise interference or antenna effect and so on, associated with other communication techniques when verifying radio frequency (RF) chips, are eliminated. Compared with other wireless communication techniques, the IR communication technique improves reliability of test results. Thus, the product verification systems of the invention can be widely applied for all kinds of chips.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for product verification, comprising:
a first machine for controlling the system; and
a second machine receiving a test command from the first machine to perform a test procedure on a product according to the test command, and then to transmit a test result to the first machine,
wherein the first and second machines communicate with each other by an inferred (IR) means.

2. The system as claimed in claim 1, wherein the first machine comprises:
a first IR transceiving module for transmitting the test command to the second machine and receiving the test result from the second machine;
a first control unit for providing the first IR transceiving module with the test command transmitted to the second machine; and
a storage unit storing the test result received by the first IR transceiving module.

3. The system as claimed in claim 1, wherein the second machine comprises:
a second IR transceiving module for receiving the test command from the first machine and transmitting the test result to the first machine; and
a second control unit for testing the product according to the test command received by the second IR transceiving module, and collecting the test result transmitted to the first machine by the second IR transceiving module.

4. The system as claimed in claim 2, wherein the first control unit uses parallel communication.

5. The system as claimed in claim 4, wherein the first IR transceiving module comprises:
a first parallel-to-serial converting module coupled to the first control unit for converting the test command from a parallel format to a serial format;
a first transmitting processing unit for generating an IR modulated test command by loading the serial format test command with an identification code (ID code) and then performing an IR modulation process to the serial format test command loaded with the ID code; and
a first IR transmitter for transmitting the IR modulated test command by the IR modulation process.

6. The system as claimed in claim 4, wherein the first IR transceiving module further comprises:
a first IR receiver for receiving an IR signal;
a first receiving processing unit coupled to the first IR receiver for receiving the IR signal, performing an IR demodulation process on the IR signal and identifying an identification code (ID code) thereof to obtain the test result from the second machine; and
a first serial-to-parallel converting module coupled to the first receiving processing unit for receiving the test result and converting the test result from a serial format to a parallel format to be sent to the first control unit.

7. The system as claimed in claim 3, wherein the second control unit uses parallel communication.

8. The system as claimed in claim 7, wherein the second IR transceiving module further comprises:
a second IR receiver for receiving an IR signal;
a second receiving processing unit coupled to the second IR receiver for receiving the IR signal, performing an IR demodulation process on the IR signal and identifying an identification code (ID code) thereof to obtain the test command from the first machine; and
a second serial-to-parallel converting module coupled to the second receiving processing unit for receiving the test command and converting the test command from a serial format to a parallel format to be sent to the second control unit.

9. The system as claimed in claim 7, wherein the second IR transceiving module comprises:
a second parallel-to-serial converting module coupled to the second control unit for receiving the test result, and converting the test result from a parallel format to a serial format;
a second transmitting processing unit for generating an IR modulated test result by loading the serial format test result with an identification code (ID code) and then performing an IR modulation process to the serial format test result loaded with the ID code; and
a second IR transmitter for transmitting the IR modulated test result by infrared.

10. The system as claimed in claim 1, wherein the product is a die on a wafer or a separate die sliced from a wafer.

11. The system as claimed in claim 1, wherein the test procedure is a wafer probe test or an electrical characteristic test.

12. A system for product verification, comprising:
a). a first machine for controlling the system and wherein the first machine includes:
a first inferred (IR) transceiving module for transmitting or receiving data by an IR means;
a first control unit for providing a test command to the the first IR transceiving module transmitted by the first IR transceiving module;
a storage unit for storing data received by the first IR transceiving module; and
b). a second machine, wherein the second machine includes:
a second IR transceiving module for receiving the test command transmitted from the first IR transceiving module and transmitting a test result by infrared;
a second control unit for performing a test procedure on a product according to the test command received by the second IR transceiving module and collecting the test result transmitted by the second transceiving module.

13. The system as claimed in claim 12, wherein the first control unit uses parallel communication.

14. The system as claimed in claim 13, wherein the first IR transceiving module comprises:
a first parallel-to-serial converting module coupled to the first control unit for receiving the test command, and converting the test command from a parallel format to a serial format;
a first transmitting processing unit for generating an IR modulated test command by loading the serial format test command with an identification code (ID code) and then performing an IR modulation process to the serial format test command loaded with the ID code; and
a first IR transmitter for transmitting the IR modulated test command by infrared.

15. The system as claimed in claim 13, wherein the first IR transceiving module further comprises:
a first IR receiver for receiving an 1R signal;
a first receiving processing unit coupled to the first IR receiver for receiving the IR signal, performing an IR demodulation process on the IR signal and identifying an identification code (ID code) thereof to obtain the test result from the second machine; and
a first serial-to-parallel converting module coupled to the first receiving processing unit for receiving the test result and converting the test result from a serial format to a parallel format to be sent to the first control unit.

16. The system as claimed in claim 12, wherein the second control unit uses parallel communication.

17. The system as claimed in claim 16, wherein the second IR transceiving module further comprises:
a second IR receiver for receiving an IR signal;
a second receiving processing unit coupled to the second IR receiver for receiving the IR signal, performing an IR demodulation process on the IR signal and identifying an identification code (ID code) thereof to obtain the test command from the first machine; and
a second serial-to-parallel converting module coupled to the second receiving processing unit for receiving the test command and converting the test command from a serial format to a parallel format to be sent to the second control unit.

18. The system as claimed in claim 16, wherein the second IR transceiving module comprises:
a second parallel-to-serial converting module coupled to the second control unit for receiving the test result, and converting the test result from a parallel format to a serial format;
a second transmitting processing unit for generating an IR modulated test result by loading the serial format test result with an identification code (ID code) and then performing an IR modulation process to the serial format test result loaded with the ID code; and
a second IR transmitter, transmitting the IR modulated test result by infrared.

19. The system as claimed in claim 12, wherein the product is a die on a wafer or a separate die sliced from a wafer.

20. The system as claimed in claim 19, wherein the test procedure is a wafer probe test or an electrical characteristics test.
